(19) United States
(12) Patent Application Publication
(10) Pub. No.: US 2004/0137314 A1
(43) Pub. Date: Jul. 15, 2004

(54) Battery

(75) Inventor: Shigeaki Fukui, Yokohama-shi (JP)

Correspondence Address: SCHULTE ROTH & ZABEL LLP, ATTN: JOEL E. LUTZKER, 919 THIRD AVENUE, NEW YORK, NY, 10022, US

(73) Assignee: Kyocera Corporation, Kyoto-shi (JP)

(21) Appl. No.: 10/672,377

(22) Filed: Sep. 26, 2003

(30) Foreign Application Priority Data
Sep. 30, 2002 (JP) 2002-287797

(51) Int. Cl. H01M 10/50; H01M 2/34

(52) U.S. Cl. 429/62; 429/7

(57) ABSTRACT

A battery includes a battery cell, a circuit base board which is connected to terminals in the battery cell electrically via connection members, a heat protecting element, disposed in the connecting members, in which electric resistance increases according to an increase in a temperature therein, and a resin mold section which covers the circuit base board, the connecting members, and the heat protecting element so as to fix thereof on the battery cell. The heat protecting element is disposed so as to be separated from a surface of the battery cell via the resin mold section. By doing this, it is possible to increase electric resistance in the heat protecting element due to overcurrent normally in a battery which is provided with a heat protecting element so as to protect the electronic apparatus such as a mobile phone.

### BACKGROUND OF THE INVENTION

1. Field of the Invention

The present invention relates to a battery which is provided with a heat protecting element which protects an electronic apparatus from an overcurrent.

Priority is claimed on Japanese Patent Application No. 2002-287797, filed Sep. 30, 2002, the content of which is incorporated herein by reference.

2. Description of Related Art

A battery which has conventionally provided commonly comprises a battery cell, electronic parts for controlling a charge/discharge for the battery cell, a circuit base board which has connecting terminals so as to connect to the electronic apparatuses electrically, and a resin mold section which fixes the battery cell and the circuit base board unitarily such that the battery can be mounted in a portable electronic apparatus such as a mobile phone, a mobile terminal device, and a videocamera (see Patent Document 1 below).

The battery cell and the circuit base board are connected electrically by the connecting members. A PTC (Positive Temperature Coefficient) element (heat protecting element) is provided in the battery cell and the circuit base board.

The PTC element has a characteristic in which an electric resistance increases when the PTC is heated. Therefore, when a short circuit occurs in an electricity supply circuit in the battery and an overcurrent occurs, an electric resistance in the PTC increases due to Joule's heat which is caused by the overcurrent. Consequently, electricity is stopped from the battery; thus, an electronic apparatus can be protected. Also, the PTC element has a characteristic in which electric resistance which is heated from a normal temperature and cooled to the normal temperature is greater than the electric resistance under non-heated condition (initial resistance).

It is preferable that the electric resistance in the PTC element should be as much lower as possible in the normal temperature when the battery is attached to the electronic apparatus so as to be used such that an electricity can be supplied to the electronic apparatus efficiently.

Patent Document 1: Japanese Unexamined Patent Application, First Publication No. 2000-315483 (page 7, FIGS. 12 to 15)

However, the PTC element is disposed on a surface of the battery cell; thus, the battery cell takes heat from the heated PTC cell. That is, it is deterred that the temperature increases in the PTC cell. Therefore, the increase in the electric resistance is not sufficient in the PTC element; thus, the supply of the electricity from the battery cell is not stopped appropriately. Accordingly, there has been a problem in that the electronic apparatus cannot be protected sufficiently.

Also, the PTC cell is disposed so as to contact the surface of the battery cell, thus, a resin mold section cannot be formed between the PTC cell and the surface of the battery cell. Therefore, there has been a concern that the PTC cell may be removed from the surface of the battery cell.

### SUMMARY OF THE INVENTION

The present invention was made in consideration of the above problems. An object of the present invention is to provide a battery which can protect the electronic apparatus reliably by increasing normally the electric resistance due to the overcurrent in the PTC cell.

In order to solve the above problem, in a first aspect of the present invention, a battery comprises a battery cell, circuit base board which is connected to terminals in the battery cell electrically via connection members, a heat protecting element, disposed in the connecting members, in which electric resistance increases according to an increase in a temperature therein; and a resin mold section which covers the circuit base board, the connecting members, and the heat protecting element so as to fix thereof on the battery cell. In this aspect of the present invention, it is also preferable that the heat protecting element is disposed so as to be separated from a surface of the battery cell via the resin mold section.

According to the battery of the present invention, heat is insulated between the heat protecting element and a surface of the battery cell by the resin mold section. Therefore, heat which is generated in the heat protecting element is not absorbed by the battery cell. Therefore, the electric resistance increases normally when the battery is connected to an electronic apparatus such as a mobile phone so as to supply electricity to the electronic apparatus and the heat protecting element is heated by the Joule's heat due to the overcurrent; thus, supply of electricity is stopped to the electronic apparatus.

Also, the heat protecting element is covered by the resin mold section such that the heat protecting element is disposed so as to be separated from a surface of the battery cell. Therefore, the heat protecting element is never separate from the surface of the battery cell.

In a second aspect of the present invention, the heat protecting element is covered by a heat insulating member which has heat insulating characteristics to thereoutside.

In the battery of the present invention, the circuit base board, the connecting member, and the heat protecting element are fixed to the battery cell unitarily by the resin mold section such , and a melt resin is poured into a die in which the circuit base board and the terminals in the battery cell are connected by the connecting members. Consequently, although the battery cell and the circuit base board are heated by the melt resin, the heat protecting element which is covered by the insulating member is never heated. Therefore, it is possible to prevent an increase in the electric resistance of the heat protecting element in a normal temperature.

Also, as a third aspect of the present invention, the heat insulating member is a heat insulating sleeve which is provided an insertion section through which the heat protecting element can be inserted.

In the battery of the present invention, the insulating sleeve can be attached to the heat protecting element only by inserting the heat protecting element through an insertion section. Therefore, it is possible to cover the heat protecting element easily.

Also, in a fourth aspect of the present invention, the connecting member is made of a metal plate.

In the battery of the present invention, it is possible to retain the heat protecting element by the metal plate easily such that the heat protecting element should be separated from a surface of the battery cell. Therefore, it is possible to fill the melt resin between the heat protecting element and a surface of the battery cell when a resin mold section is formed.

As explained above, according to the first aspect of the present invention, an electric resistance increases normally when the heat protecting element is heated due to the overcurrent; thus, the supply of the electricity to the electronic apparatus is stopped, therefore, it is possible to protect the electronic apparatus reliably. Also, the resin is filled in a space between the heat protecting element and a surface of the battery cell; therefore, it is possible to form the heat protecting element and the battery cell unitarily by the resin mold section reliably.

Also, according to the second aspect of the present invention, the heat protecting element is covered by the insulating member; therefore, it is possible to prevent an increase in electric resistance (alleviation resistance) in the heat protecting element when the resin mold section is formed. Therefore, it is possible to supply electricity to the electronic apparatus efficiently when the battery is attached to the electronic apparatus so as to be used.

Also, according to the third aspect of the present invention, the heat insulating member is a heat insulating sleeve which is provided an insertion section through which the heat protecting element can be inserted. Therefore, it is possible to cover the heat protecting element by the insulating member easily; thus, it is possible to shorten the manufacturing time for the battery.

Also, according to the fourth aspect of the present invention, the connecting member is made of a metal plate. By doing this, it is possible to retain the heat protecting element easily such that the heat protecting element should be separated from a surface of the battery cell. Therefore, it is possible to fill the melt resin between the heat protecting element and a surface of the battery cell when a resin mold section is formed. By doing this, it is possible to fill the melt resin between the heat protecting element and a surface of the battery cell reliably when the resin mold section is formed.

### BRIEF DESCRIPTION OF THE DRAWINGS

FIG. 1 is a perspective view for a battery according to an embodiment of the present invention.

FIG. 2 is a perspective view showing a battery cell, a circuit base board, and a connecting plate in the battery of FIG. 1 in a disassembled manner except the resin mold section.

FIG. 3 is a cross section of a PTC element section in a battery of FIG. 1.

FIG. 4 is a plan view of the battery shown in FIG. 1 under previous condition that the resin mold section is formed.

FIG. 5 is an enlarged cross section of an important part of the battery shown in FIG. 1.

FIG. 6 is an enlarged cross section of an important part of the battery as other embodiment of the present invention.

FIGS. 7A and 7B are perspective views for an insulating sleeve which is used for a battery according to other embodiment of the present invention.

FIG. 8 is an enlarged cross section of the insulating sleeve which is attached to the PTC element.

FIG. 9 is a cross section which is viewed horizontally for a battery according to other embodiment of the present invention.

FIG. 10 is a plan view of a cross section for a battery according to other embodiment of the present invention.

### DETAILED DESCRIPTION OF THE INVENTION

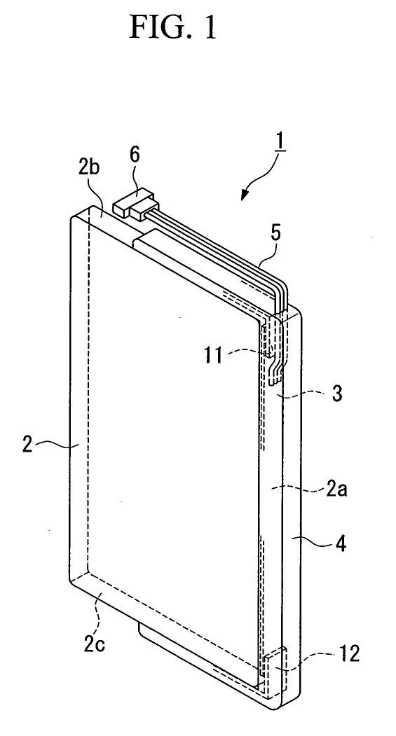

FIGS. 1 to 5 show an embodiment according to the present invention. As shown in FIG. 1, a battery 1 in the embodiment of the present invention is attached to a portable electronic apparatus such as a mobile phone to be used. The battery 1 comprises a rectangular battery cell 2, a circuit base board 3 which is disposed along a side surface 2a of the battery cell 2, a resin mold section fixed on side surfaces 2a, 2b, 2c of the battery cell 2 so as to cover the circuit base board 3, a cable 5 which is exposed out of the resin mold section 4, and a connecting terminal 6 which is disposed on tip of the cable 5 so as to be connected to the electronic apparatus electrically.

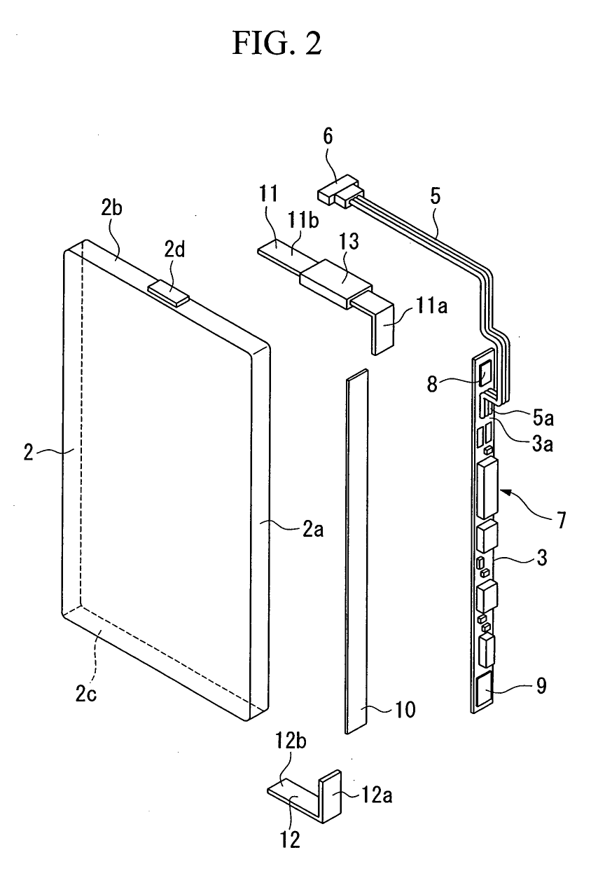

As shown in FIG. 2, a cathode terminal 2d is disposed in a center of the side surface 2b of the battery cell 2 so as to protrude therefrom. The rest of the surface of the side surface 2b is an anode terminal. Here, the protruding cathode terminal 2d is insulated from the side surface 2b electrically.

The circuit base board 3 is provided with a plurality of electric parts 7 for controlling charge/discharge for the battery cell 2 and land sections 8, 9 so as to be connected with terminals of the battery cell 2 such that the circuit base board 3 should be fixed on the side surface 2a of the battery cell 2 via an adhesive tape 10. Also, a terminal section 5a of the cable 5 is connected to a surface 3a of the base board 3.

The battery cell 2 and the circuit base board 3 are connected electrically by a connecting plates (connecting members) 11, 12.

Metal plates made of, for example, a nickel plate are bent in L-letter shape; thus, connecting plates 11, 12 are formed. Terminal sections 11a, 12a are connected to the land sections 8, 9 by a spot welding operation or a soldering operation. Also, terminal sections 11b, 12b which are formed on the other side of the connecting plates 11, 12 are connected to a side surface 2c which forms a cathode terminal 2d and an anode terminal by a spot welding operation or a soldering operation. A PTC element section 13 is formed on a terminal section 11b which is formed on an end of the connecting plate 11.

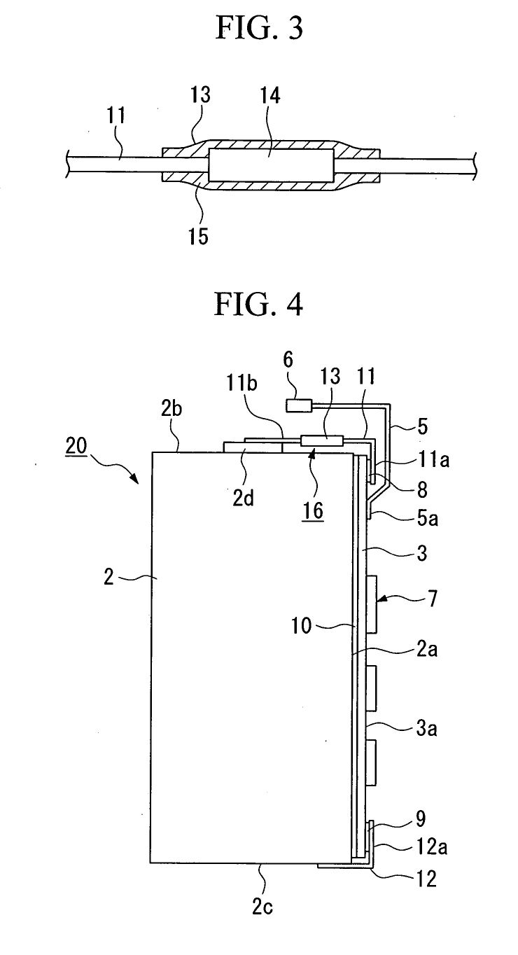

As shown in FIG. 3, the PTC element section 13 comprises a PTC element (heat protecting element) 14 which is formed on the connecting plate 11 and a heat insulating tape (heat insulating member) 15 which covers the PTC element 14.

As explained above, the PTC element 14 has a characteristic in which the electric resistance in the PTC element 14 increases rapidly when the PTC element 14 is heated. Also, the heat insulating tape 15 insulates heat between the PTC element 14 and thereoutside. The heat insulating tape 15 is made of an aramid resin or a polyethyleneterephthalate which are formed in a tape. The heat insulating tape 15 is rolled around the PTC element 14 so as to be attached on the PTC element 14.

A method for manufacturing a battery having the above structure is explained as follows.

First, as shown in FIG. 2, the electric parts 7 and the land sections 8, 9 are mounted on a surface 3a of the circuit base board 3. Simultaneously, an end section 5a of the cable 5 which is attached to the connecting terminal 6 is connected to the surface 3a of the circuit base board 3 by a soldering operation. Next, as shown in FIG. 4, a back surface 3b of the circuit base board 3 and the side surface 2a of the battery cell 2 are fixed together by the adhesive tape 10.

Also, a heat insulating tape 15 is attached on the PTC element 14 which is formed on the connecting plate 11 so as to form the PTC element section 13. After that, end sections 11a, 12a on the connecting plates 11, 12 are connected to the land sections 8, 9 respectively. Simultaneously, other end sections 11b, 12b are connected to the cathode terminal 2d of the battery cell 2 and the anode terminal; thus, a battery unit 20 is formed. By doing this, a space 16 is formed between the PTC element section 13 and a side surface of the battery cell 2.

Consequently, the battery unit 20 is contained in a mold which is not shown in the drawing. The mold is provided with cavities for forming the resin mold section 4 shown in FIG. 1 while containing the battery unit 20. A pouring port from which a melt resin is poured is formed on the mold such that a pouring port should face to the cavities.

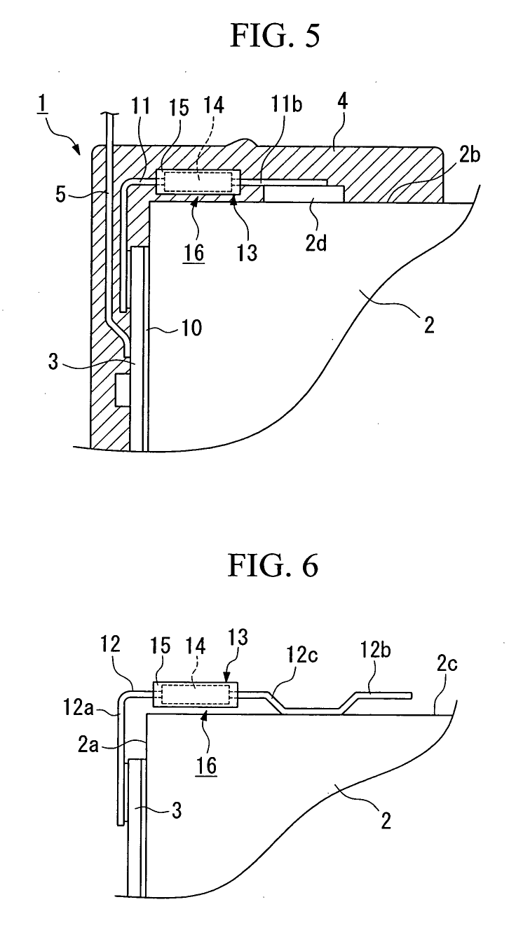

Finally, the melt resin is filled in the space 16 by pouring the melt resin from the pouring port while covering the circuit base board 3, the connecting plates 11, 12, and the PTC element section 13 as shown in FIG. 5. Thus, the resin mold section 4 is formed.

The battery 1 which is manufactured as explained above is connected to an electronic apparatus such as a mobile phone; thus, it is possible to supply electricity to the electronic apparatus. When an overcurrent occurs during supplying the electricity, the electric resistance in the PTC element 14 increases due to Joule's heat based on the overcurrent; thus, the supply of the electricity from the battery 1 is stopped so as to protect the electronic apparatus.

In the above battery 1 according to the above embodiment, the battery cell 2 and the PTC element 14 are thermally insulated from each other by the resin mold section 4 and the adhesive tape 15. Therefore, even if the PTC element 14 is heated by the Joule's heat, the heat is not absorbed by the battery cell 2. By doing this, electric resistance in the PTC element 14 increases normally; thus, the supply of electricity is stopped to the electronic apparatus. Thus, it is possible to protect the electronic apparatus reliably.

Also, when the resin mold section 4 is formed, the PTC element 14 is not heated by heat in the melt resin because the PTC element 14 is covered by the heat insulating tape 15. By doing this, it is possible to prevent electric resistance (alleviation resistance) from increasing in the PTC element 14 under normal temperature condition. Therefore, it is possible to supply electricity to the electronic apparatus efficiently when the battery 1 is attached to the electronic apparatus to be used.

Furthermore, the connecting plate 11 is made of a metal plate; thus, it is possible to retain the PTC element 14 so as to be separate from the side surface 2b of the battery cell 2 easily. Therefore, it is possible to fill the melt resin in a space 16 between the PTC element 14 and the side surface 2b when the resin mold section 4 is formed.

By doing this, the PTC element 14 is covered by the resin mold section 4 such that the PTC element 14 should be separated from the side surface 2b of the battery cell 2. Therefore, it is possible to form the PTC element 14 and the battery cell 2 unitarily reliably by the resin mold section 4.

Here, in the above embodiment, explanation has been made under condition that the PTC element 14 is formed on the connecting plate 11. More importantly, the present invention is not limited to such an embodiment. That is, it is acceptable if the PTC element 14 may be formed, for example, on an end section 12b on the connecting plate 12 as shown in FIG. 6.

In such a case, it is necessary to separate the PTC element 14 from the side surface 2c by deforming a region of the end section 12b which is bonded to the side surface 2c of the battery cell 2, and the PTC element 14.

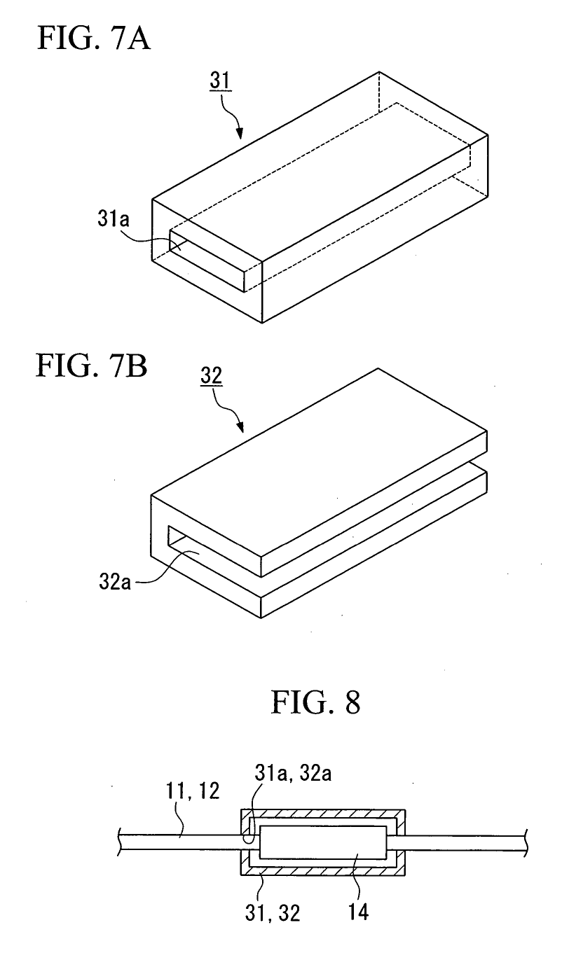

Also, in the above embodiment, explanations have been made under condition that the PTC element 14 is covered by the heat insulating tape 15. However, more importantly, the present invention is not limited to such an embodiment. That is, for example, it is acceptable if the PTC element 14 is a heat insulating sleeve (heat insulating member) 31 having a through hole (insertion section) 31a as shown in FIG. 7A. Also, it is acceptable if the PTC element 14 is a heat insulating sleeve (heat insulating member) 32 having a notched section (insertion section) 32a as shown in FIG. 7B.

The heat insulating sleeves 31, 32 are made of a heat insulating synthetic resin such as an aramid resin or a polyethyleneterephthalate. The heat insulating sleeves 31, 32 can be attached to the PTC element 14 only by inserting the PTC element 14 in the through hole 31a or in the notched section 32a. Therefore, it is possible to cover the PTC element 14 easily; thus, it is possible to shorten a manufacturing time for the battery 1.

Alco, it is acceptable if the heat insulating sleeves 31, 32 may cover the PTC element 14 such that the heat insulating sleeves 31, 32 have a space between the heat insulating sleeves 31, 32 and the PTC element 14 as shown in FIG. 8.

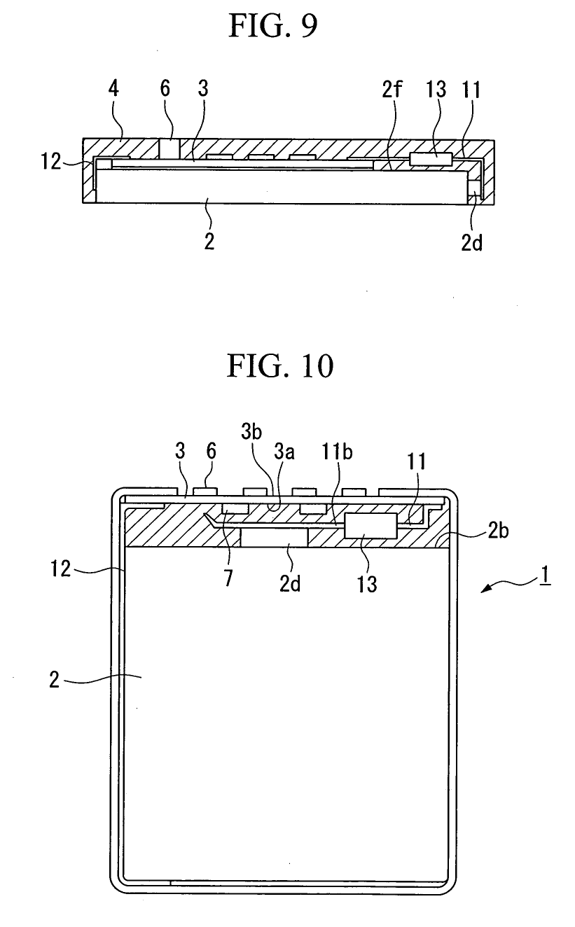

In the above embodiment, explanations have been made under condition that the circuit base board is attached to a side surface 2a of the battery cell 2. More importantly, the present invention is not limited to the above embodiment. That is, for example, it is acceptable if the circuit base board may be attached on a surface 2f which is larger than the side surface 2a as shown in FIG. 9. In such a case, it is possible to dispose the PTC element section 13 on an end section of the connecting plate 11 such that the PTC element 14 should be separated from the surface 2f of the battery cell 2.

Also, in the above embodiment, explanations have been made under condition that the circuit base board 3 is fixed on the side surface 2a or the surface 2f. More importantly, the present invention is not limited to the above embodiment. That is, for example, it is acceptable if the surface 3a of the circuit base board 3 should be disposed to fact the side surface 2b of the battery cell 2 as shown in FIG. 10 and the connecting plate 11 on which the PTC element 14 is disposed should be disposed between the battery cell 2 and the circuit base board 3.

In such a case, the connecting plate 11 is bent appropriately so as to attach the PTC element section 13 on the cathode terminal 2d and the surface 3a of the circuit base board 3 such that the PTC element section 13 should not contact the battery cell 2 and the circuit base board 3.

In the battery cell 2 having above structure, it is possible to cover the electronic parts 7 which are mounted on the surface 3a of the circuit base board 3 and the PTC element section 13 only by filling the resin between the battery cell 2 and the circuit base board 3. Therefore, it is possible to save the resin for forming t the resin mold section 4; thus, it is possible to reduce a manufacturing cost.

Also, in such a case, it is acceptable if the connecting terminal 6 which is connected to the electronic apparatus electrically may be mounted on the back surface 3b of the circuit base board 3 directly. By doing this, it is not necessary to use a cable for connecting the connecting terminal 6 and the circuit base board 3; therefore, it is possible to realize a small battery 1.

Specific embodiments therefor have been shown by way of example in the drawings and detailed description. The invention disclosed herein is susceptible to various modifications and alternative forms. It should be understood, the invention is to cover all modifications, equivalents and alternatives falling within the scope of the present invention as defined by the claims.

What is claimed is:

1. A battery comprising:
a battery cell;
circuit base board which is connected to terminals in the battery cell electrically via connection members;
a heat protecting element, disposed in the connecting members, in which electric resistance increases according to an increase in a temperature therein; and
a resin mold section which covers the circuit base board, the connecting members, and the heat protecting element so as to fix thereof on the battery cell, wherein
the heat protecting element is disposed so as to be separated from a surface of the battery cell via the resin mold section.

2. A battery according to claim 1 wherein the heat protecting element is covered by a heat insulating member which has heat insulating characteristics to there outside.

3. A battery according to claim 2 wherein the heat insulating member is a heat insulating sleeve which is provided an insertion section through which the heat protecting element can be inserted.

4. A battery according to claim 1 wherein the connecting members are made of a metal plate.

5. A battery according to claim 2 wherein the connecting members are made of a metal plate.

6. A battery according to claim 3 wherein the connecting members are made of a metal plate.
